(19) United States
(12) Patent Application Publication
(10) Pub. No.: US 2006/0278466 A1
(43) Pub. Date: Dec. 14, 2006

(54) ELECTRIC POWER STEERING SYSTEMS

(76) Inventor: Bo Cheng, Troy, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 11/421,177

(22) Filed: May 31, 2006

Related U.S. Application Data
(60) Provisional application No. 60/689,788, filed on Jun. 13, 2005.

(51) Int. Cl. B62D 5/04

(52) U.S. Cl. 180/444

(57) ABSTRACT

A power steering system is provided for assisting with steering the wheels of a motor vehicle and includes two or more electrical motors that are selectively energized by an electronic control unit. The motors may be drivingly connected to the steering wheel shaft, or drivingly connected to the steering wheel pinion that meshes with the steering rack, or be drivingly connected to the steering rack. The motors may be drivingly connected through various transmission arrangements in including gears, ball nuts, belt and pulleys, or chain and sprockets, speed reduction gears and clutches. The electronic control unit can selectively control the motors to run all at once, or to run individually, as desired.

### CROSS-REFERENCES TO RELATED APPLICATIONS

This application claims the benefit of U.S. provisional application Ser. No. 60/689,788 filed Jun. 13, 2005.

### FEDERALLY SPONSORED RESEARCH OR DEVELOPMENT

Not applicable.

### FIELD OF THE INVENTION

The present invention relates to an electric power assist steering system for a motor vehicle and more particularly to a power steering system having two or more electric motors.

### BACKGROUND OF THE INVENTION

It is well known to equip modern motor vehicles with power assisted steering systems. Traditionally, a hydraulic pump, of either a rotary or linear type, is suitably connected into the steering mechanism and is actuated in response to the driver turning the steering wheel in order to aid in turning the vehicle wheels. Power steering is particularly desirable during low speed driving and parking maneuvers.

Traditional hydraulic power steering systems have provided remarkable performance for many years in terms of handling, cost, and convenience. However, these systems require a hydraulic pump driven off the vehicle engine, and have the drawback of adding drag on the engine equal to a decrease of about 5 horsepower. The hydraulic pump runs regardless of whether steering assistance is required. In fact, the power consumption of the pump is highest at high speed, when steering assistance is least needed.

Automobile manufacturers are moving to electric power assist steering (EPS) to provide the convenience of steering assist without the cost in engine load and fuel consumption caused by the hydraulic power steering systems. Electric power steering provides a more flexible and more efficient steering system than a conventional hydraulic system. In general, an electric power steering system employs an electric motor instead of a hydraulic pump. Electric power is provided by the conventional vehicle electrical system, including a battery and an alternator. A principle advantage of electric power steering is that electrical current is used only when the power steering motor is energized, thereby eliminating the parasitic losses that result from the constant operation of a hydraulic pump in the prior art hydraulic systems. Besides providing up to a five percent improvement in fuel efficiency, EPS is lighter, and is mechanically simpler by eliminating the necessity for a pump, a drive belt, and a fluid reservoir.

However, the steering assistance possible for any electric power steering system with a single electric motor is limited by the maximum electrical current acceptable from the vehicle's electrical system. For typical 12V automotive electrical systems, one motor can accept a peak maximum current of about 80 amps, thus limiting peak power to only approximately one Kilowatt. As a result, the application of electric power steering is limited to smaller vehicles, such as the compact or medium class of cars. Some vehicle manufacturers are developing 42V electrical systems as a means of providing additional electrical power for use in electric power steering. However, 42V electrical systems add considerable cost and complexity to the vehicle and it would be desirable to provide alternative solutions as a means to enable the easy adoption of electrical power assist steering to larger vehicles, and even heavy trucks.

Another challenge in the design of power steering systems is minimizing system cost, and maximizing robustness, safety, as well as providing flexibility in the packaging of the steering components within the crowded environment of the motor vehicle's front end and engine compartment. The prior art has recognized the need for design flexibility by teaching that the electrical power steering motor can be positioned to input its power assist into the steering column shaft at a point somewhere between the steering wheel and the steering pinion that meshes with the steering rack. Other designs have the electric motor input directly at the steering shaft pinion, while yet other designs have the electric motor input at the steering rack.

Thus, while significant strides have been made toward the successful implementation and market place acceptance of electric power assist steering, the long term adoption and success of this technology requires further improvement, in the power, performance, cost, flexibility, reliability and size of such systems.

### SUMMARY OF THE INVENTION

A power steering system is provided for assisting with steering the wheels of a motor vehicle and includes two or more electrical motors that are selectively energized by an electronic control unit. The motors may be drivingly connected to the steering wheel shaft, or drivingly connected to the steering wheel pinion that meshes with the steering rack, or be drivingly connected to the steering rack. The motors may be drivingly connected through various transmission arrangements including gears, ball screws and ball nuts, belt and pulleys, or chain and sprockets, speed reduction gears and clutches. The electronic control unit can selectively control the motors to run all at once, or to run individually, as desired.

Thus, a feature, object and advantage of the invention is that in the event of the failure or damage to one of the motors, the other motor can continue to provide power assist.

Another feature, object, and advantage is that the durability of both motors and mechanical components are improved, and the size and weight of the motors, gearbox and other mechanical components are reduced, by spreading the steering load over one or more transmission arrangements connecting the motors to the steering system.

Yet another feature, object, and advantage is that manufacturing, inventory and component costs are reduced by enabling the design of standard modular motor, gearbox, and transmission packages that can be added as needed to provide the needed level of power assist.

Furthermore, another feature, object, and advantage is that one or more of the multiple motors in a power assisted steering system are connected through clutches, enabling selective disconnect of a motor to avoid inertia losses and resistance, and selective connection of a motor to provide power assist when assist is needed in furtherance of the power steering control strategy.

Another feature, object, and advantage is that the ability to distribute the weight and package size of steering components within the vehicle's chassis is enhanced because the separate motors can be individually located at selected locations to optimize their weight distribution and also fit within the close confines of the vehicle's architecture.

Another feature, object, and advantage is that the use of multiple motors instead of a single motor enables creative control strategies such as running one motor at low steering loads and multiple motors at high steering loads, or running both motors in tandem, or running one motor if the other fails, as controlled by algorithms residing in the steering system's electronic control unit.

Another feature, object, and advantage is that splitting the steering assist between multiple motors enables the selection of motors that are different from each other, such as one high speed motor with a low speed motor, one high power motor with a low power motor, one brushless motor with one brush-type motor, as desired for system design flexibility.

Further, areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an electric power steering system constructed in accordance with the present invention;

FIG. 2 is a schematic representation of a control system for controlling the electric motors of the power steering system of FIG. 1;

FIG. 3 is a schematic similar to FIG. 1 but showing a second embodiment of the invention;

FIG. 4 is a schematic similar to FIG. 1 but showing a third embodiment of the invention;

FIG. 5 is a schematic similar to FIG. 1 but showing a fourth embodiment of the invention;

FIG. 6 is a schematic similar to FIG. 1 but showing a fifth embodiment of the invention;

FIG. 7 is a schematic similar to FIG. 1 but showing a sixth embodiment of the invention;

FIG. 8 is a schematic similar to FIG. 1 but showing a seventh embodiment of the invention;

FIG. 9 is a schematic similar to FIG. 1 but showing an eighth embodiment of the invention;

FIG. 10 is a schematic similar to FIG. 1 but showing a ninth embodiment of the invention;

FIG. 11 is a schematic similar to FIG. 1 but showing a tenth embodiment of the invention;

FIG. 12 is a schematic similar to FIG. 1 but showing a tenth embodiment of the invention;

FIG. 13 is a schematic similar to FIG. 1 but showing an eleventh embodiment; and

FIG. 14 is a schematic similar to FIG. 1 but showing a twelfth embodiment.

### DETAILED DESCRIPTION OF THE PREFERRED EMBODIMENTS

The following description of certain exemplary embodiments is merely exemplary in nature and is not intended to limit the invention, its application, or uses.

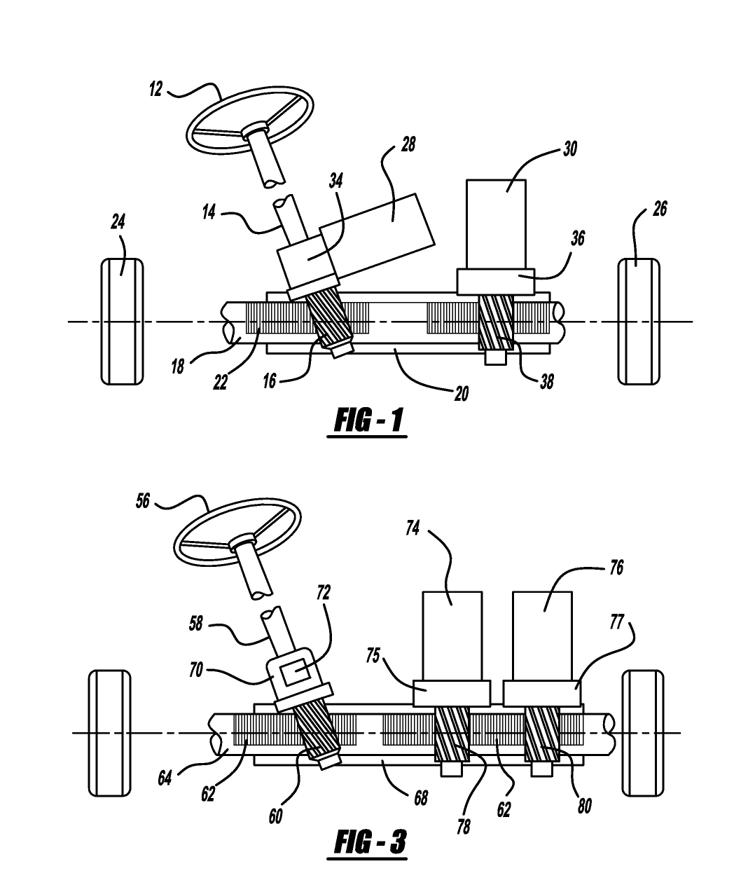

Referring to FIG. 1, the steering system of a motor vehicle includes a steering wheel 12 that is mounted on a rotatable steering shaft 14. A pinion gear 16 is mounted on the end of the steering shaft 14 and meshes with a rack 18. The rack 18 is a shaft that is mounted within a housing 20 in a manner that permits the rack 18 to move axially within the housing 20 while preventing the rack 18 from rotating. The rack 18 has rack teeth 22 formed thereon which mesh with the pinion gear 16 so that rotation of the pinion gear 16 by turning the steering wheel 12 will move the rack 18 axially within the housing 20. The ends of the rack 18 are connected to the wheels 24 and 26 by linkages that are well known and not shown in the drawings, such that the axial movement of the rack 18 will turn the vehicle wheels 24 and 26.

The steering system of FIG. 1 has an electric power assist mechanism including a pair of electric motors 28 and 30. Electric motor 28 has a gearbox 34 that is connected to the steering shaft 14 and the pinion gear 16. Electric motor 30 has a gearbox 36 that drives a pinion gear 38 that meshes with the rack teeth 22 of the rack 18. The gearboxes 34 and 36 each include a speed reduction gear set to reduce the speed of the electric motors 28 and 30. As seen in FIG. 1, the electric motors 28 and 30, together with their respective gearboxes 34 and 36 are suitably mounted on the rack housing 20.

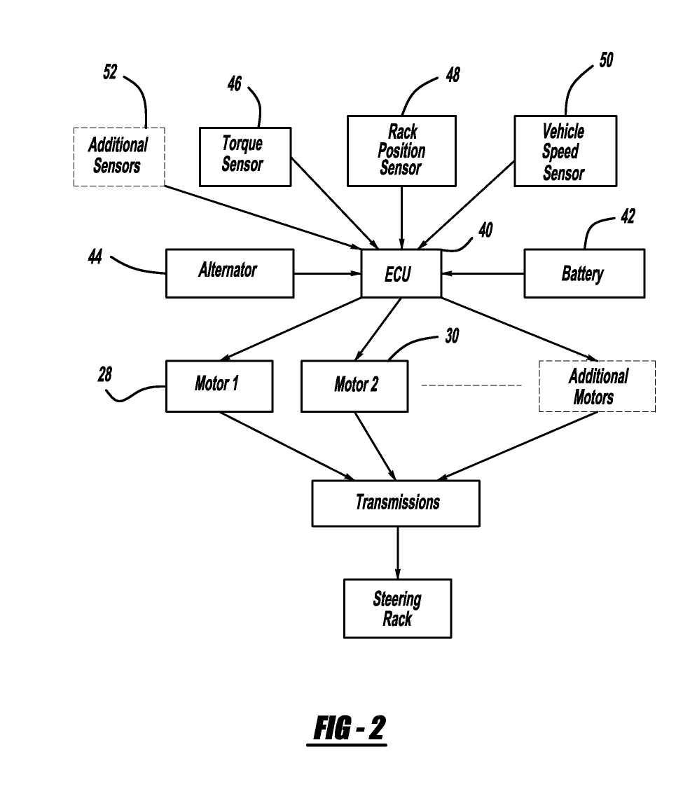

Referring to FIG. 2, a control system is provided for controlling the electric motors 28 and 30. An electrical control unit 40 receives electrical current from the vehicle's electrical system, including a battery 42, an alternator 44 or other alternate power source. The electrical control unit 40 receives sensory inputs from various sensors, including a steering wheel torque sensor 46 that is located within the steering wheel 12 or steering gearbox 34, a rack position sensor 48 that senses the axial position of the rack 18 within the rack housing 20, and a vehicle speed sensor 50. Additional sensors, represented at 52 may be employed, if appropriate and depending upon the sophistication of the control strategy that will be employed. The electronic control unit 40 processes data signals received from these sensors 46, 48 and 50, and, in response, transmits current to the electric motors 28 and 30. The electric motors are connected to the steering rack 18 by any of the various power transmission units that will be described hereinafter.

In operation, it will be appreciated that when the driver turns the steering wheel 12, torque is transmitted into the steering shaft 14 and the steering shaft 14 will rotate the pinion gear 16, which in turn translates the rack 18 axially within the housing 20 to turn the vehicle wheels 24 and 26. The driver is assisted in steering the vehicle by steering effort that is contributed by the electric motors 28 and 30, to an extent that will be determined by the various input sensors 46, 48 and 50 and the control strategy that is programmed into the electronic control unit 40. In this regard, it will be understood and appreciated that the two electric motors 28 and 30 enable the implementation of control strategies that are otherwise not obtainable with a single motor. For example, the two electric motors 28 and 30 can be run simultaneously so that each electric motor is contributing to the steering effort. Or, for example, only one of the electric motors can be energized during lower demand steering occasions, such as high speed vehicle travel, or both of the electric motors can be run at high torque demand occasions, such as when parking the vehicle. The electric motors 28 and 30 and their associated gearboxes 34 and 36 can be identical in terms of speed output and torque, or the electric motors 28 and 30 may be different. For example, it may be desirable to have a light duty motor for use in low demand circumstances, and a heavy duty motor for use in high demand circumstances. Or it may be desirable to have a high speed motor for parking maneuvers at low speed, and a slow speed motor for high speed steering.

FIG. 3 shows another embodiment of the invention. In FIG. 3, the steering wheel 56 is mounted on a steering shaft 58 and a pinion gear 60 that meshes with the rack teeth 62 provided on the rack 64 that is axially movable within the rack housing 68. A sensor housing 70 encloses a torque sensor 72 and a position sensor 48. Two electric motors 74 and 76 are mounted side by side on the rack housing 68. The electric motor 74 and its associated gearbox 75 have a pinion gear 78 that meshes with the rack teeth 62 on the rack 64. The electric motor 76 and its associated gearbox 77 have a pinion gear 80 that meshes with the rack teeth 62 on the rack 64. It will be understood that because each of the electric motors 74 and 76 have their own pinion gears 78 and 80, and these pinion gears 78 and 80 are separate from the steering shaft pinion gear 60, the electric motors 74 and 76 may be mounted at whatever location is convenient along the length of the rack 64. For example, if desired, the electric motor 74 can be mounted on one side of the steering shaft pinion gear 60 and the other electric motor 76 can be mounted on the other side of the steering shaft pinion gear 60. Thus, the vehicle design engineer will have considerable latitude in choosing a location for the electric motors 74 and 76 that will most desirably package the steering system into the crowded environment of the modern motor vehicle.

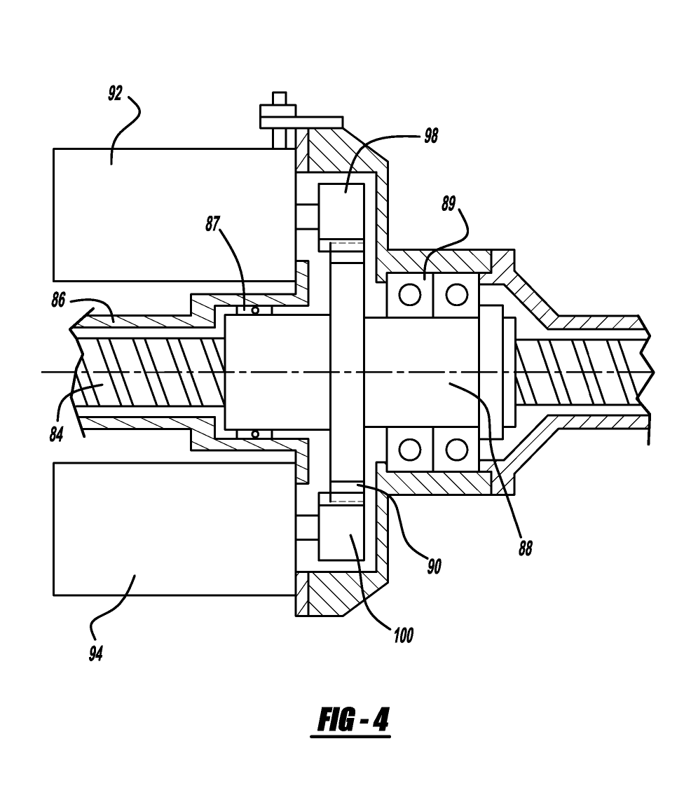

FIG. 4 shows yet another embodiment of the invention. In FIG. 4, the rack is a threaded ball screw shaft 84 that is axially moveable within the rack housing 86. The ends of the ball screw shaft 84 are constrained so that the ball screw shaft 84 cannot rotate. The steering wheel, not shown, is conventionally connected to the ball screw shaft 84 by a steering wheel shaft and a pinion gear, not shown in FIG. 4. A ball nut 88 is rotatably mounted within the rack housing 86 by roller bearing assemblies 87 and 89. The ball nut 88 encircles the ball screw shaft 84 and contains balls, not shown, that mesh with the exterior screw surface of the ball screw shaft 84. A ring or large gear 90 encircles the ball nut 88 and is attached to the ball nut 88. A pair of electric motors 92 and 94 is mounted on the rack housing 86. The electric motor 92 has a pinion gear 98 that meshes with the large gear 90 and electric motor 94 has a pinion gear 100 that meshes with the large gear 90. Whenever one or both of the electric motors 92 and 94 are energized, the large gear 90 will be rotated and will in turn rotate the ball nut 88. The ball nut 88 acts through the balls contained therein to move the ball screw shaft 84 in either the rightward or leftward axial direction, depending upon the direction of rotation of the electric motors 92 and 94. Thus, it is seen and appreciated that in the arrangement of FIG. 4, the ring gear 90, the ball nut 88 and the ball nut shaft 84 cooperate to define a common transmission that has two power inputs, that is, the two electric motors 92 and 94. Furthermore, it will be appreciated that the input to the ring gear 90 is not limited to just two electric motors, but rather a third and fourth electric motor can be added as necessary or desirable, space permitting.

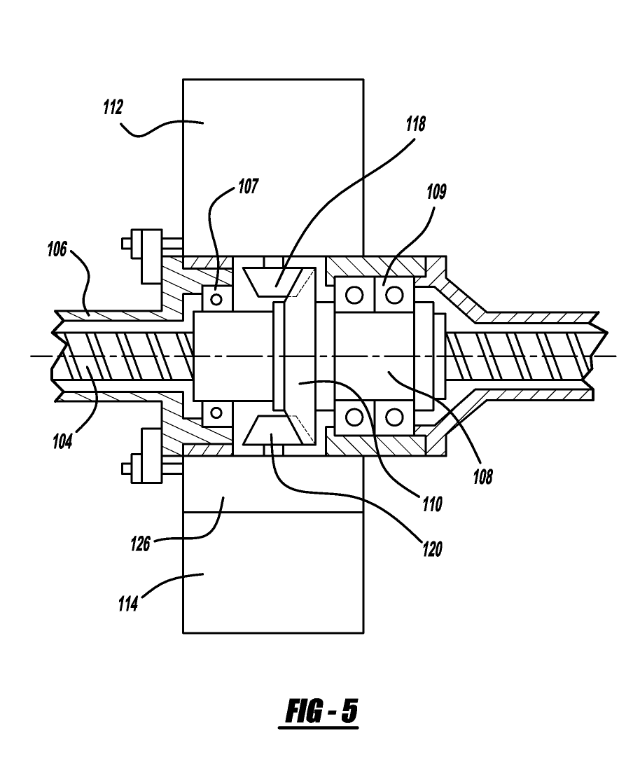

Yet another embodiment of the invention is shown in FIG. 5. In FIG. 5, the rack is a threaded ball screw shaft 104 that is axially moveable within the rack housing 106. The ends of the threaded ball screw shaft 104 are constrained so that the threaded ball screw shaft 104 cannot rotate. The steering wheel, not shown, is conventionally connected to the threaded ball screw shaft 104 by a steering wheel shaft and a pinion gear, not shown in FIG. 5. A ball nut 108 is rotatably mounted within the rack housing 106 by roller bearing assemblies 107 and 109. The ball nut 108 encircles the threaded ball screw shaft 104 and contains balls, not shown, that mesh with the exterior screw surface of the threaded ball screw shaft 104. A large bevel or ring gear 110 encircles the ball nut 108 and is attached to the ball nut 108. A pair of electric motors 112 and 114 is mounted on the rack housing 106. As seen in the drawing, the electric motors 112 and 114 are mounted with their respective output shafts oriented at 90 degrees to the axis of the ball nut 108 and the axis of the large bevel gear 110. The electric motor 112 has a bevel pinion gear 118 that meshes with the large bevel gear 110 and electric motor 114 has a bevel pinion gear 120 that meshes with the large gear 110. Whenever one or both of the electric motors 112 and 114 are energized, the large gear 110 will be rotated and will in turn rotate the ball nut 108. The ball nut 108 acts through the balls contained therein to move the threaded ball screw shaft 104 in either the rightward or leftward axial direction, depending upon the direction of rotation of the electric motors 112 and 114. Thus, it is seen and appreciated that in the arrangement of FIG. 5, the ring gear 110, the ball nut 108 and the threaded ball screw shaft 104 cooperate to define a common transmission that has two power inputs, that is the electric motors 112 and 114. FIG. 5 also shows a clutch 126 associated with the electric motor 114. The clutch 126 may be an electrical clutch or other type of clutch, depending upon the control strategy that is to be employed in conjunction with the power steering system. If needed, a clutch 126 may also be associated with the electric motor 112, 92, 94, 74, 76, 28 and 30.

By comparing the arrangements of FIGS. 4 and 5, it will be appreciated that the mounting orientation of the electric motors 92, 94, 112 and 114 can be varied by beveling the gear teeth on the motor driven pinion and the large gear 90 and 110 that is attached to the ball nut 88 and 108. Thus, the design engineer has the flexibility to place the orientation of the electric motors 92, 94, 112 and 114 as needed to fit within the crowded confines of the vehicle's front end. In addition, it will be appreciated that although FIGS. 4 and 5 each show that the electric motors 92, 94, 112 and 114 are mounted at diametrically opposed locations on opposite sides of the rack, these motors can just as well be mounted closer together as desirable to package the power steering system within the crowded vehicle's front end. For example, one motor can be mounted horizontally with respect to the roadway, and the other motor can be mounted vertically. In addition, the motor input to the large gear is not limited to just two electric motors, but rather a third and fourth electric motor can be added as necessary or desirable.

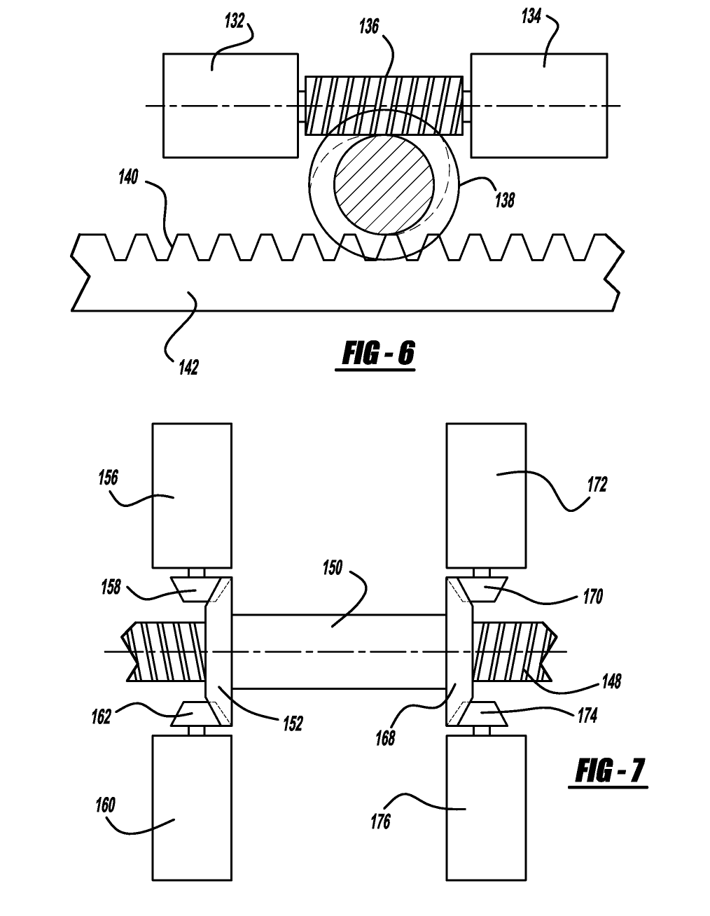

FIG. 6 shows another embodiment of the invention. In FIG. 6, the electric motors 132 and 134, a worm 136, and a worm gear 138 are all mounted upon a housing, not shown. The electric motors 132 and 134 are connected on opposite ends of the worm 136, and the electric motors 132 and 134 turn in opposite direction of one another. The worm 136 meshes with the worm gear 138, and the worm gear 138 engages a component 140 such as a ball nut, a pinion shaft or a steering column should this arrangement be used to engage a rack 142 directly the rack must have a helical spur gear to mesh with the worm gear 138. Thus, when one or both of the electric motors 132 and 134 are energized, the worm 136 and the worm gear 138 cooperate to provide a common transmission to provide power assist for steering of the vehicle. Of course, if desired, a speed reduction gear set, as well as a clutch, may be associated with either, or both of the electric motors 132 and 134.

Another embodiment of the invention is shown in FIG. 7. In FIG. 7, the rack is a threaded ball screw shaft 148 that is axially moveable within a rack housing, not shown. The ends of the threaded ball screw shaft 148 are constrained so that the threaded ball screw shaft 148 cannot rotate. The steering wheel, not shown, is conventionally connected to the threaded ball screw shaft 148 by a steering wheel shaft and a pinion gear, not shown in FIG. 7. A ball nut 150 is rotatably mounted within the rack housing that meshes with the exterior screw surface of the threaded ball screw shaft 148 through balls, not shown. A large bevel gear 152 is attached to the left end of the ball nut 150. The electric motor 156 has a small bevel gear 158 that meshes with the large bevel gear 152. The electric motor 160 has a small bevel gear 162 that meshes with the large bevel gear 152. As seen in FIG. 7, the electric motors 156 and 160 are mounted with their respective output shafts oriented at 90 degrees to the axis of the ball nut 150 and the axis of the large bevel gear 152, however, it will be understood that the use of bevel gears permits the electric motors 156 and 160 to be mounted at other angles, as might be desired to package the power steering system within the vehicle. Another large bevel gear 168 is mounted on the right hand end of the ball nut 150 and meshes with a small bevel gear 170 of a third electric motor 172 and with a small bevel gear 174 of a fourth electric motor 176. Whenever one or more of the motors is energized, the large bevel gears 152 and 168 will be rotated and will rotate the ball nut 150. The ball nut 150 acts through the balls contained therein to move the threaded ball screw shaft 148 in either the rightward or leftward axial direction, depending upon the direction of rotation of the electric motors 156, 160, 172 and 176. Thus, it is seen and appreciated that in the arrangement of FIG. 7, the large bevel gears 152 and 168, the ball nut 150, the small bevel gears 158,162,170 and 174 and the ball screw cooperate to define a common transmission that has four power inputs, that is the electric motors 156, 160,172 and 176. The electric motors 156, 160, 172 and 176 may have gearboxes and clutches, if desired.

FIG. 8 shows another embodiment in which pair of ball nut assemblies 180 and 182 encircles a ball screw 184. A first electric motor 186 is connected with the ball nut assembly 180 by a large bevel gear 188 and a small bevel gear 190. A second electric motor 194 is connected with the ball nut assembly 182 by a large bevel gear 198 and a small bevel gear 200. The steering wheel, not shown, is conventionally connected to the ball screw 184 by a steering wheel shaft and a pinion gear, not shown in FIG. 8.

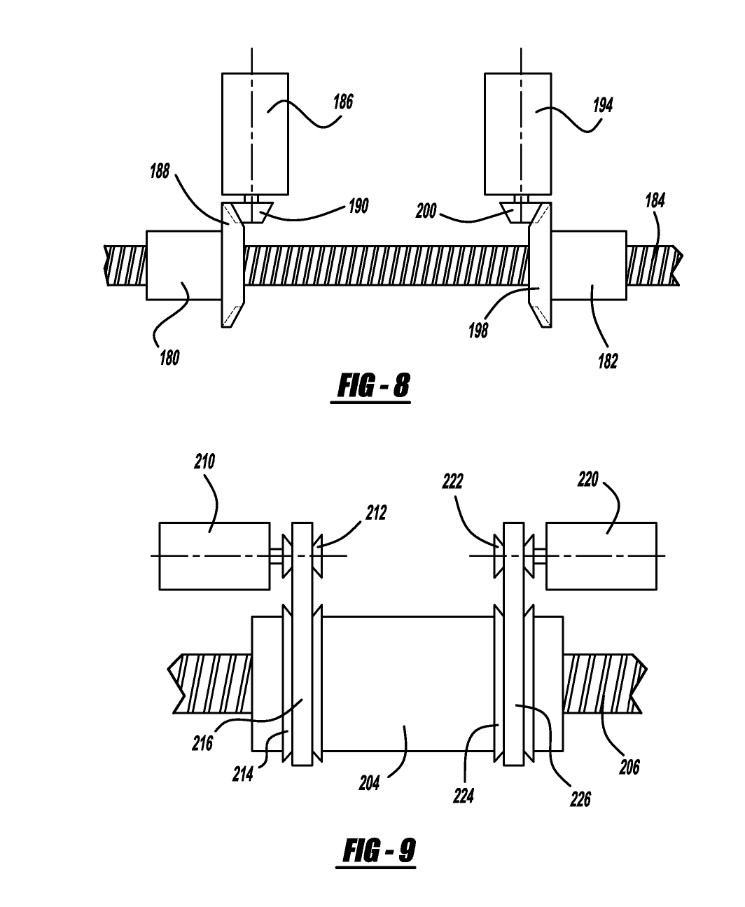

FIG. 9 shows an embodiment in which a single ball nut 204 meshes with a ball screw 206. Electric motor 210 drives a pulley 212. A pulley 214 is mounted on the ball nut 204 and a rubber belt 216 connects the pulley 212 and pulley 214. Electric motor 220 drives a pulley 222. A pulley 224 is mounted on the ball nut 204 and a rubber belt 226 connects the pulley 222 and the pulley 224. As an alternative to the use of pulleys and rubber belts, the electric motors 210 and 220 can be connected to the ball screw by a drive chain and toothed chain sprockets, not shown.

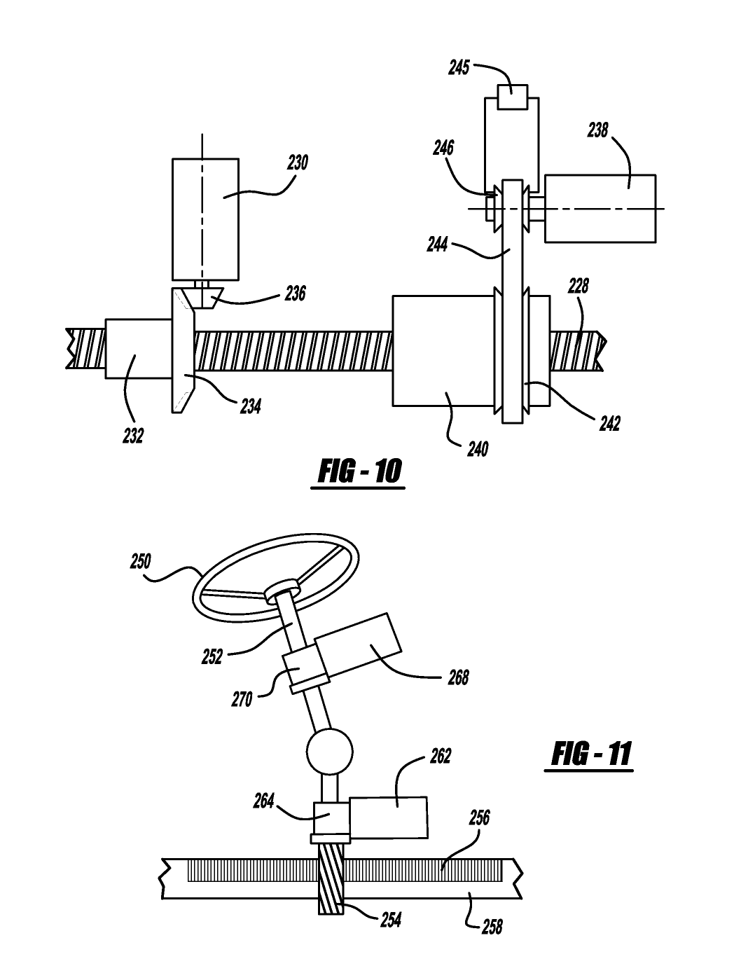

FIG. 10 is another embodiment of the invention. The electric motor 230 is connected to a ball screw 228 by a ball nut 232, a large bevel gear 234, and a small bevel gear 236. The electric motor 238 is connected to a ball nut 240 by a pulley 242, a belt 244 and a pulley 246. An appropriate belt tensioning device 245 is placed in the arrangement to maintain high efficiency drive.

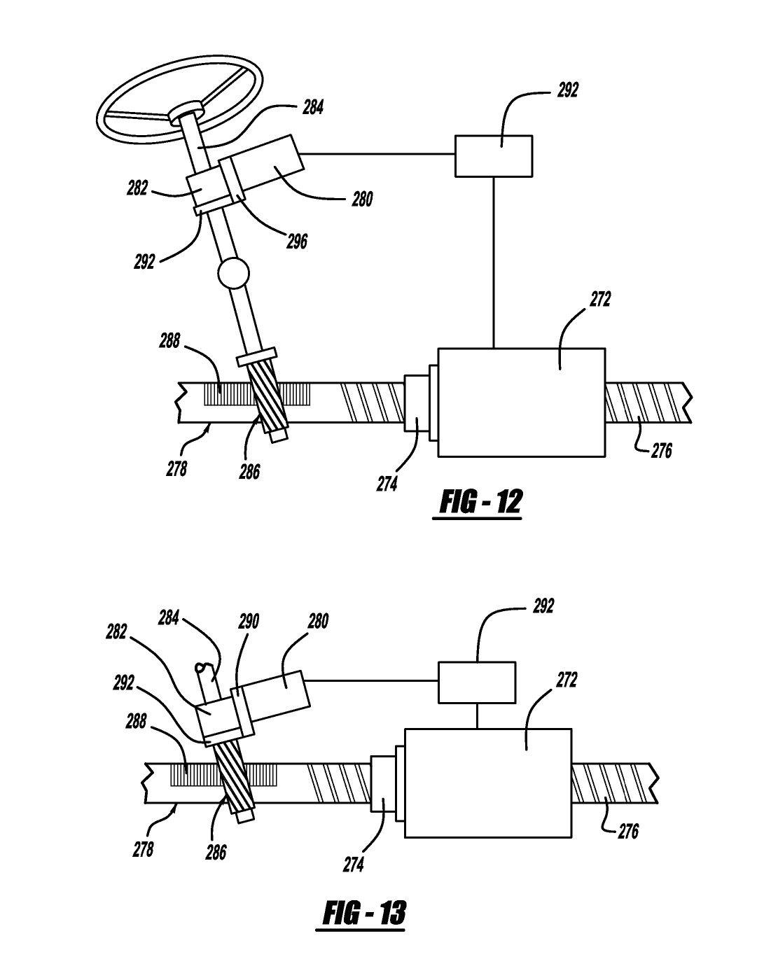

In FIG. 11, another embodiment is shown. A steering wheel 250 is mounted on the steering shaft 252. A pinion 254 is attached to the end of the steering shaft 252 and meshes with the rack teeth 256 of rack 258. A first electric motor 262 has a gearbox 264 that drives the pinion 254. A second electric motor 268 has a gearbox 270 that drives the steering shaft 252. Thus, both of the electric motors 262 and 268 drive the rack 258 through the steering shaft 252 and pinion 254.

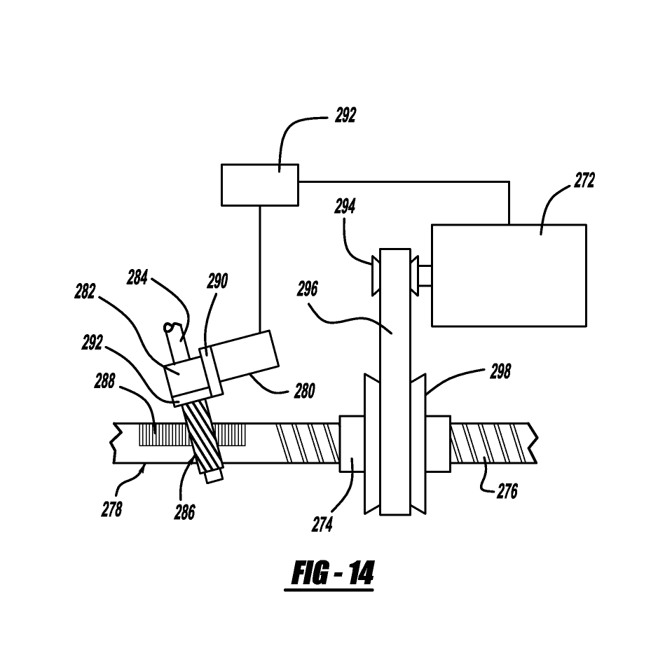

FIGS. 12 and 13 are further embodiments of the invention in which a first motor 272 and ball nut 274 assembly are directly mounted to a ball screw 276 formed on a portion of the rack 278. The second motor 280, similar to the embodiment of FIG. 10, has a gearbox 282 that drives the steering shaft 284. A pinion 286 is attached to the end of the steering shaft 284 and meshes with the rack teeth 288 of the rack 278. In this embodiment a clutch 290 is mounted between the gearbox 282 and the second motor 280. Also, a sensor is mounted to the gearbox and together both motors communicate with an ECU 292 which monitors the operating characteristics of the overall system. FIG. 13 is very similar to the embodiment of FIG. 12 with the exception that the pinion 286 that meshes with the rack teeth 288 of the rack 278 is directly attached to the gearbox 282 while the end of the steering shaft 284 is directly attached to the gearbox 282.

In FIG. 14, the first motor 272 drives a pulley 294 and through a timing belt 296 and a second pulley 298, attaches to a ball nut 274 that connects to the ball screw 276 formed on a portion of the steering rack 278. The arrangement of the second motor 280 is basically the same as that illustrated in FIG. 13.

In view of the foregoing embodiments, it is seen that the automotive designers have considerable latitude in designing a power steering system that is economical, reliable and readily packageable within motor vehicles. Two or more motors can be connected to the steering rack via a variety of power transmission arrangements. Two small motors can be packaged easier than one large motor. And one motor can be more powerful than the other, or run at a different speed than the other. The motors may have different gear box arrangements and different clutch arrangements to provide for operating a single motor while overriding the second motor. And the motors can be operated together, or operated separately according to the control strategy chosen by the designer. In the event of damage or failure to one of the motors, another motor can provide redundancy and thereby assure reliability.

As is readily evident from the various embodiments described above, the use of multiple motors in an electric power assist steering system (EPS) offers many advantages over the prior art EPS using a larger single motor. The safety advantage of having the ability to continuous control of the steering of the vehicle upon failure of a single motor is obvious. The use of existing electrical architecture is a large cost advantage. Further, the use of multiple motors with an appropriate control system provides the flexibility to operate the motors in unison or alternatively, pulsing the motors to maximize the available power to each motor in an alternating manner. The multiple motor arrangements further provide for lower noise, vibration and harshness since the phase of each motor can be controlled to cancel out the NVH of the second motor. Also, because each motor operates at a lower current, there is less heat generated from the system being used on a vehicle, as well as a smaller motor will adapt better to packaging considerations.

The elimination of hydraulic steering pump fluids also presents significant advantages in terms of overall efficiency and environmental problems. Power is used on demand. The electronic control unit can provide more power at lower speeds while lower power demand at higher speeds are easily accommodated because the assist force is shared between multiple mechanical components. For example, a smaller gear box can be designed for the application. Also, a gear box designed for smaller vehicles can also be utilized for larger vehicles with multiple motors. The invention lends itself to increased flexibility for base-design platform sharing.

The foregoing description of the invention is merely exemplary in nature and, thus, variations thereof are intended to be within the scope of the invention and the appended claims.

What is claimed is:

1. A power steering system for steering the wheels of a motor vehicle, comprising:
a rack member connected to said wheels to steer said wheels when said rack member is moved axially; and
a plurality of electric motors drivingly connected to said rack member to move said rack member axially.

2. The power steering system as claimed in claim 1 in which each of said electric motors is connected to said rack member by a transmission.

3. The power steering system as claimed in claim 2 in which each of said electric motors are connected to a common transmission that connects said electric motors to said rack member.

4. The power steering system as claimed in claim 3 in which said common transmission is a gear set having each of said plurality of electric motors as an input to said gear set.

5. The power steering system as claimed in claim 1 in which a steering wheel is connected to a steering wheel pinion gear that meshes with said rack member so that turning said steering wheel moves said rack member axially and at least a first one of said electric motors is connected to said rack member via the steering wheel pinion gear.

6. The power steering system as claimed in claim 5 in which a second electric motor is connected to said rack member by a transmission that is separate from said steering wheel pinion gear.

7. The power steering system as claimed in claim 1 in which each of said electric motors drive the steering wheel shaft and a pinion connects said steering wheel shaft to the steering rack.

8. The power steering system as claimed in claim 1 in which at least one of said electric motors has a clutch associated therewith to enable the selective connection and disconnection of at least one of said electric motors from said rack member.

9. The power steering system as claimed in claim 2 in which said rack member is a threaded shaft and said transmission for connecting at least one of said electric motors to said threaded shaft contains a ball nut that is rotated about said threaded shaft by said electric motor to thereby move said threaded shaft axially.

10. The power steering system as claimed in claim 1 in which said rack member is a threaded shaft and a ball nut encircles said threaded shaft and at least two of said electric motors are drivingly connected to said ball nut so that energization of either of said electric motors will rotate said ball nut and thereby move said rack member axially to assist steering.

11. A power steering system for steering the wheels of a motor vehicle, comprising:
a rack member connected to said wheels to steer said wheels when said rack member is moved axially;
a steering wheel mounted on a steering wheel shaft and a pinion carried by said steering wheel shaft and meshing with said rack member to manually move said rack member axially;
a first electric motor drivingly connected to said rack member to assist movement of said rack member axially when said first electric motor is actuated;
a second electric motor drivingly connected to said rack member to assist movement of said rack member axially when said second electric motor is actuated; and
an electronic control unit for individually controlling each of said plurality of electric motors.

12. The power steering system as claimed in claim 11 in which said rack member is a threaded shaft, a ball nut encircles said threaded shaft, and said first and second electric motors are selectively energizable to drive said ball nut.

13. The power steering system as claimed in claim 12 in which gears connect said first and second electric motors to said ball nut so that said motors can be mounted to have an axis of rotation that is anywhere from parallel to perpendicular with respect to the axis of the axial movement of said threaded shaft.

14. The power steering system as claimed in claim 12 in which at least one of said electric motors is connected to said ball nut by a belt and pulleys.

15. The power steering system as claimed in claim 12 in which at least one of said electric motors is connected to said ball nut by a chain and sprocket.

16. The power steering system as claimed in claim 11 in which said electric motors drive the opposite ends of a worm, and said worm meshes with a worm gear that meshes with said rack member.

17. A power steering system for steering the wheels of a motor vehicle, comprising:
a steering wheel mounted on a steering shaft that carries a steering pinion;
a rack member connected to said wheels to steer said wheels when said rack member is moved axially and said steering pinion meshes with said rack member;
a plurality of electric motors drivingly connected to said rack member to move said rack member axially; and
an electronic control unit for individually controlling each of said plurality of electric motors.

18. The power steering system as claimed in claim 17 in which the electronic control unit causes said plurality of electric motors to run at the same time.

19. The power steering system as claimed in claim 17 in which the electronic control unit causes one or the other of said electronic motors to run.

20. The power steering system as claimed in claim 17 in which at least one of said plurality of electric motors is connected to said rack member by an electric actuated clutch that is controlled by said electronic control unit.
